(19) United States
(12) Patent Application Publication
(10) Pub. No.: US 2009/0044041 A1
(43) Pub. Date: Feb. 12, 2009

(54) Redundant Data Bus System

(76) Inventors: Michael Armbruster, Stuttgart (DE); Sascha Paasche, Esslingen (DE); Reinhard Reichel, Stockach (DE); Andreas Schwarzhaupt, Landau (DE); Gernot Spiegelberg, Heimsheim (DE); Armin Sulzmann, Oftersheim (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/631,654

(22) PCT Filed: Jan. 15, 2005
(86) PCT No.: PCT/EP2005/000375

§ 371 Date: Apr. 1, 2008

(30) Foreign Application Priority Data
Jul. 6, 2004 (DE) 10 2004 032 779.3

(51) Int. Cl. G06F 11/00

(52) U.S. Cl. 714/3; 714/E11.003

(57) ABSTRACT

A redundant data bus system has two data buses between which at least two failsafe control devices are connected. The two data buses operate with the same data bus protocol at essentially the same transmission frequency, and safety-related control messages are transmitted in parallel via both data buses and processed in the control devices. Each control device performs a separate control task via assigned control software. Each control device has two microcomputers which operate independently of one another and which have software for both the first and the second control tasks. When one control device fails, the control task can also be performed by the other. One data interface is arranged between the two microcomputers, via which result data calculated from the safety-related control messages can be exchanged and compared with one another. Based on such comparison a decision means determines which microcomputer or control device carries out a control task.

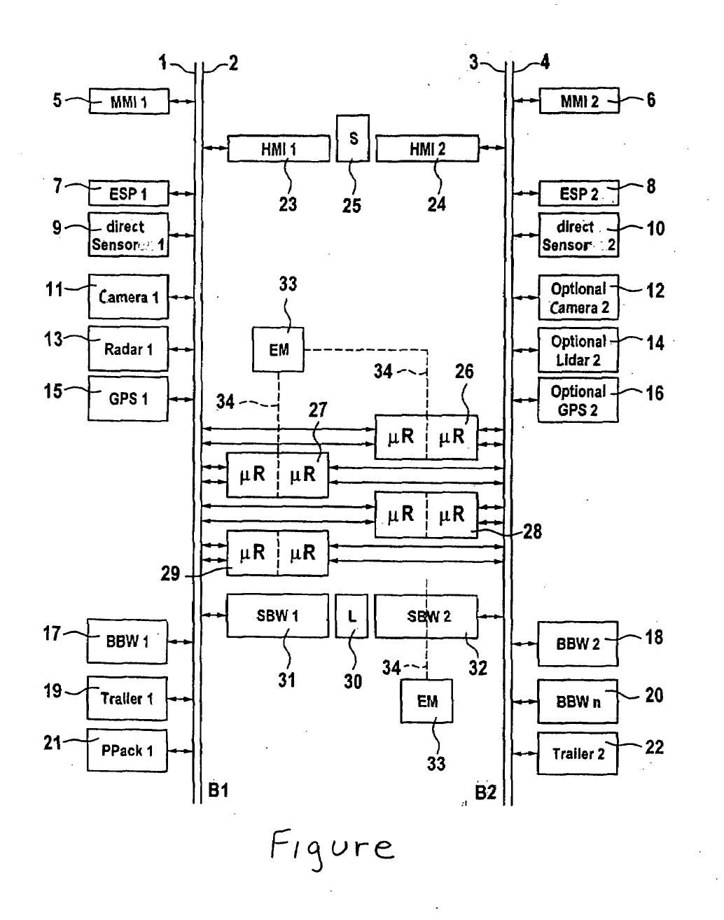

This application claims the priority of German patent document 10 2004 032 779.3, filed Jul. 6, 2004 (PCT International Application No. PCT/EP2005/000375, filed Jan. 15, 2005) the disclosures of which are expressly incorporated by reference herein.

### BACKGROUND AND SUMMARY OF THE INVENTION

The invention relates to a redundant data bus system comprising two data buses between which at least two failsafe control devices are connected; the two data buses operate with the same data bus protocol, for example a synchronous CAN or FlexRay protocol, at essentially the same transmission frequency. Safety-related control messages are transmitted in parallel via both data buses and processed in the control devices, and each of the control devices carries out a separate control task which is processed by means of assigned control software.

Known redundant data bus systems are generally used in applications that are critical for safety in motor vehicles or in aircraft are known. Such a data bus system is disclosed, for example, in the periodical “Technische Rundschau” [Technical Overview] No. 18, 2001, on pages 42 to 45. The FlexRay data bus has been developed for electrically actuating vehicle steering, brakes or safety systems. For safety reasons, the most important systems have to be implemented in duplicate and connected to both channels (i.e., to both separate FlexRay data bus channels). Less safety-critical sensors or actuators, on the other hand, can be connected to a control device which is connected to just one data bus channel.

The FlexRay data bus system has two separate data bus lines which transmit messages using the same data protocol. Safety-critical control devices are connected to both data buses and can therefore evaluate and possibly compare the two message streams. If the messages for a control device which are received by the different data buses differ, it is possible to detect a fault. However, more detailed information on such fault detection methods is not illustrated.

U.S. Pat. No. 5,694,542 also discloses a redundant data bus system, in which each control device is connected simultaneously to the two data bus channels of the data bus system. In order to ensure that the connected control devices are functionally capable, the message of each control device is provided with a membership field in which in the event of a fault the information indicating that the control device has failed is stored for the other control devices.

UK patent document GB 2 345 153 A discloses a microcomputer arrangement having two microcontrollers which are independent of one another. The first microcontroller controls the actuators of a brake system, while the second has a diagnostic function and carries out bus monitoring. If a fault is detected on the basis of the bus monitoring or a direct exchange of data between the microcontrollers, the second microcontroller carries out an emergency communication. The second microcontroller serves as a shadow computer which in the event of a fault can carry out certain functions of the first microcontroller. The microcomputer arrangement or its microcontrollers are connected to a single fault-tolerant two-conductor data bus.

European patent document EP 0 732 654 A1 discloses a method for fault-tolerant communication under high real-time conditions, in which a double bus architecture is provided, one node with two microcontrollers being arranged between two CAN data buses. Each CAN data bus in turn is a two-conductor data bus. Each data bus is used in the event of a fault as a watchdog data bus in order, in the event of a fault, to signal the fault to the other users. The control function is not transferred to the other microcontroller but rather the faulty message is overwritten.

One object of the present invention is to provide a decision structure for a data bus system, such that the data bus system remains functionally capable despite a faulty control device.

This and other objects and advantages are achieved by the redundant data bus system according to the invention in which each control device has two microcomputers that operate independently of one another, and that have the control software for both the first and the second control tasks. Accordingly, when one control device fails, the control task can also be carried out by the other control device. The result data items which are calculated on the basis of the safety-related control messages can be exchanged and compared with one another via a data interface which is arranged within the control device, between the two microcomputers. Based on comparison of the result data items, a decision means decides which microcomputer or which control device carries out a control task.

According to the invention, a data bus system is provided with control devices (for example for actuating the engine, the transmission and the steering system). Control data are transmitted via the data bus system in the form of electronic messages, and an actuator (for example an electric motor) then implements the actual steering of the wheels. Control devices which are connected to only one data bus are provided on the data bus system, while control devices that are referred to as dual computers are connected to both data buses of the data bus system. One data bus is in this sense a simple LIN, CAN or FlexRay data bus. In this context, each data bus can have two data bus lines, as is customary, for example, in the case of the CAN.

A synchronous communications protocol is preferably used on the two data buses of the data bus system, and time slots are provided for the individual messages, each time slot being assigned to one control device or one actuator or sensor. This arrangement makes it possible to detect that the control device has failed if there are cyclically recurring transmission times for each control device and the message which is provided does not occur. One or more time slots in which event-controlled messages can also be transmitted (i.e., cyclically nonrecurring messages are transmitted here) can also be provided in the synchronous data bus protocol.

The data bus system is of redundant design. For this purpose, two data buses of the same type on which the same communications protocol runs are provided. The messages are provided at the same frequency and with corresponding time slot sequences. For example the message protocols differ only in the time slot for event-controlled messages and in the time slots for control devices which are coupled to just one of the data buses. Sensors, actuators and control devices with safety-related tasks are configured in duplicate as a duplex (that is, with hardware modules which are the same per se).

The safety components which are embodied in duplicate have the advantage that the corresponding messages which are received via the two data buses are calculated separately in each of the duplex hardware modules and the results are compared. If they correspond, it is possible to assume that the data bus system is functioning satisfactorily. If the two calculated results differ, the data bus system carries out calculations in accordance with a predefined fault routine. In the event of a fault, another duplex control device, which is embodied in duplicate, then carries out the task; or in the case of less safety-critical errors, it is also possible for just one of the two microcomputers of the duplex control device to carry out the task, to the extent that plausibility checking has been carried out previously.

The duplicate control devices are connected, directly or via the data bus, to actuators which have to be controlled. For this purpose, the control devices can assume different function levels. These include functions for the input level (command level), with interactions via a human/machine interface, (for example via a laptop connected to the data bus) in order to input new control commands. At a different function level, the control devices operate as an embedded system, without separate communications access via a human/machine interface, and only control information is transmitted to the control devices via the data bus. The control devices which are embodied in duplicate are connected via the data bus system to the respective safety-related drive assemblies such as the engine system, transmission system or steering system.

The software architecture of the duplicate control devices separates control functions from communication functions by means of clearly defined interfaces. At the command level, operator control functions for the input unit are made available. These include commands such as monitoring the driver, informing the driver, warning the driver and the active intervention in individual system functions. Assistance systems carry out the reception of data in order to produce a representation of the surroundings for the control devices. For this purpose, the assistance systems have either single sensors or duplicate sensors which are more failsafe. Based on the representation of the surroundings (i.e., travel data, road data and data input by the driver), the duplicate control devices calculate the reaction of the drive train within its currently available power range.

In one advantageous embodiment of the invention, a master control device acts for the control task and operates when the control task runs with a fault-free sequence. The decision means transfers the control task to the other control device in the event of a fault. The data bus system has, for a control task, two control devices which are independent of one another, and which each have two microcomputers that operate independently of one another. The main memories of the four microcomputers each have the necessary software for first and second safety-related control tasks. If one control device fails, the control task can then be carried out by the other.

Each control device has two microcomputers that are connected by a data interface through which the result data items calculated from the safety-related control messages can be exchanged and compared with one another. A decision means then decides which microcomputer or which control device carries out a control task on the basis of the comparison of the result data.

The data bus system is thus multiply redundant. A master control device and a subordinate control device are always provided with the control software necessary for a control task. When the data bus system is operating correctly, the master performs the control task for the engine, for example. The messages and data from the engine sensors are each transmitted via the two data buses to the master control device in the time slots provided for that purpose. The control data items are calculated independently at each of the two microcomputers within the master control device.

When the result data is the same, satisfactory operation of the engine control device is detected and one (or both) of the microcomputers calculate new control signals, which are transmitted back to the actuators in the engine (for example the ignition, the injection means, etc.) via the two data buses. However, if the two calculated result data items in the master control device differ, the decision means assigns the calculation of the control tasks for the engine to the subordinate control device, either via the data bus or via a separate data line. For this purpose, the subordinate control device has previously already received and stored the engine control data on the data bus so that the calculation of the control data can then start up without a time delay. This ensures that in vehicle applications which are critical for safety, the control and communication on the data bus system can be carried out without a time delay, even when faults occur. This results in a failsafe data bus system in terms of the control tasks provided for it, for example for the engine, the transmission or the electric steering systems.

The control devices which are critical for safety and are embodied in duplicate include a central data management system by which the system properties of the entire vehicle are known at any time. The system is supported by a special redundancy management system which is stored in the decision means. As a result, the control devices can easily be configured and maintained by the central data management facility. Safety enquiries relating to the data bus system are carried out within one of the control devices which is configured in duplicate and plausibility calculations can be carried out on the basis of this information. As a result, the identity of both the control device at which a fault has occurred and the control device at which switching over to one of the subordinate control devices has occurred in order to perform a fault recovery, is known at any time.

The control devices which are embodied in duplicate can activate and deactivate the connected subsystems in a controlled fashion by means of a suitable wake-up signal. The system can act permanently with some or all of subsystems of the master (i.e., the sensors, actuators and subordinate control devices) and detect their system state. As a result, faults in the data bus system can be detected and correspondingly overcome. The wake-up signal is transmitted via the decision means to the assigned sensors, actuators or subordinate control devices in order to be able to switch over to another subsystem from a defective subsystem in the event of a fault. A sensor is preferably connected to one of the respective data buses for each control task and for each microcomputer of a master control device.

The embodiment in duplicate permits the functioning of sensors which are critical to safety to be checked better. In the event of a fault, it is then possible to switch over to a sensor which supplies data within the plausibility range provided. If the decision as to which sensor is functioning correctly is not possible, it is possible, if appropriate, to switch over to a subordinate control device with a further sensor. As a result, new and independent calculations can then be carried out within a short time in order to avoid a system failure in applications which are critical for safety.

In one embodiment of the invention, the redundant data bus system can provide two specific data buses which are independent of one another. Each such data bus has two separate bus lines, a data bus protocol which is time-triggered running thereon. In this way it is possible to use data buses which are normally installed in vehicles. For example, the two-conductor CAN data bus or a two-conductor FlexRay data bus is installed in the vehicle, with a first data bus installed on the left-hand side of the vehicle, and a second data bus with the two data lines installed on the right-hand side of the vehicle. On the other hand, it is also possible to install one data bus in the region of the inner roof lining of the vehicle and the other data bus in the region of the floor groups and in this way serve as a redundant data bus system.

Each microcomputer preferably has the control software for all the safety-related control tasks so that all the information for all the safety-related control tasks is provided on each control device. As a result, in the event of a fault, each control device can also function as a replacement for the master control device for any control task. During the configuration of the means of transportation, the safety-related functions which can be replaced by a specific control device are then determined. In this way identical software systems for the application software are input into the safety-related control devices.

The software on the control devices which are embodied in duplicate is programmed as fault-tolerant software at least for the drive train and carries out the control and/or coordination of the functions of the motor assemblies and transmission assemblies. The control devices are capable of collecting data from the various sensors and integrating it to form a uniform data record. The format is predefined from the outset for this data record. In this way, data in the data bus system are collected and kept up to date at all times. On the basis of this data record, the control devices can then detect whether faults have occurred in the system or whether the control devices, sensors and actuators are operating correctly during the tasks which are critical for safety.

The data record is constructed in such a way that a data fusion can be carried out on the data from the different sensors. Such a data fusion can be performed, for example at the assistance systems (such as the camera sensors, the radar sensors and GPS sensors), or the data from the different input interfaces is stored in the data record. (That is, data from the accelerator pedal, the brake and steering inputs is registered.)

The data management system for the control devices carries out functions of coordinating the individual components with one another. For example, braking, steering and engine functions are matched to one another and checked for faults. An energy management system can also be carried out by virtue of the comprehensive data availability in close to real time conditions by virtue of the data record. In this way, the energy resources are known in the entire vehicle and it is possible, for example with a hybrid drive, easily to switch over the systems of the electric motor and those of a conventional spark ignition engine. The data record can be transmitted as a message via the data bus system to all the control devices which are critical for safety and are provided for that purpose, so that each of the control devices has a current instantaneous view of the different control tasks.

Other objects, advantages and novel features of the present invention will become apparent from the following detailed description of the invention when considered in conjunction with the accompanying drawings.

### BRIEF DESCRIPTION OF THE DRAWINGS

The single FIGURE is a schematic view of the system architecture of the data bus system according to the present invention.

### DETAILED DESCRIPTION OF THE DRAWINGS

The data bus system is configured redundantly, including a first data bus B1 and a second data bus B2. The two data buses B1 and B2 are, for example, FlexRay data buses which operate at the same or at a similar transmission frequency and have the same message protocol, and the time slots which are assigned to the safety-related components can be varied, depending on the bus architecture. Each data bus B1 or B2 itself has two data bus lines (1, 2 for the data bus B1, and the 3, 4 for the data bus B2). Different components such as sensors, actuators or control devices are connected to the two data buses B1 and B2. Depending on whether the function in the vehicle (for example a car or a utility vehicle) is critical for safety, the components are either arranged only on one data bus B1, B2, or arranged between the two data buses, so that messages can be received from the two data buses B1, B2 and compared.

An electronic control device 5 is connected to the data bus B1, as a man/machine interface which controls the operator control and display elements in the vehicle. Messages for the operator control units and for the display (for example, a combination instrument) can be transmitted or received via B1. For this purpose, the control device 5 has a transceiver which can transmit and receive the data bus messages. A further control device 6, which controls another operator control/display unit and carries out the transmission of messages via the data bus B2, is connected to the data bus B2. The data buses B1 and B2 can be designed in such a way that a separate time slot is provided for the control device 5 and for the control device 6 and that the data bus protocols on the two data buses B1, B2 are identical, with one message of the control device 5 then being transmitted in the time slot of the data bus B1 which is provided for that purpose, while no transmission takes place in this time slot of the data bus B2 since the control device 5 is not connected there. In contrast, a message is then transmitted from the control device 6 onto the data bus B2 in the time slot provided for that purpose, while the time slot on the data bus B1 remains free. On the other hand, the data bus protocols can also be adapted precisely to the bus users so that the sequence of the time slots and the associated components on the two data bus systems B1 and B2 differ.

Sensors 7 and 8 for determining the yaw rate of the vehicle are each connected to one of the data buses B1 or B2 and apply the measured sensor values to the respective data bus B1 or B2. The ESP sensors 9 and 10 register specific measured variables at the vehicle and are each read in via the coupled data bus B1 or B2 so that the sensor values are available to the control devices for purposes of further processing. In this way, the sensor values at the data bus can easily be diagnosed and read out.

A camera system 11 is connected to the data bus B1 and supplies recordings or else already assigned object types or object lists from the surroundings of the vehicle. The images or data items are required for the data fusion and are compared, checked or processed together, for example with data from the radar sensors 13 or lidar sensors 14. The assistance systems of the cameras 11, 12 are connected to various software functions in order to detect pedestrians or vehicles in order to avoid an accident. Since these sensors 13, 14 and components 11, 12 support the driver as assistance systems, they are not considered to be critical for safety. As a result, it is sufficient to transmit data via a single data bus B1 or B2. If the sensor system 13, 14 fails, a warning lamp will go on in the vehicle to indicate the failure of the component. There is no provision for failure of the entire vehicle or of the entire data bus system, so that no redundant configuration or large fault tolerance is necessary here. Detection of faults can, of course, be implemented in the respective component itself by means of software.

In order to localize the vehicle, GPS components 15 and 16 are connected to the respective data buses B1 and B2 which, by means of the available software, can model a geometry model of the current surroundings of the vehicle and indicate the precise position of the vehicle. The result data of the GPS components 15 and 16 is stored as messages on the data bus B1, B2 and can therefore be used by control devices for their respective functions.

Brake components 17, 18, 20 are each provided on a data bus B1, B2 in order to actuate the brake cylinder or register brake values. The components 17, 18, 20 are each arranged as simplex components on a wheel and actuate engines or pneumatic components or hydraulic components of the brake system. The braking behavior of the vehicle can be influenced by means of these components 17, 18, 20 in accordance with specific predefined values. If a brake unit 17, 18, 20 fails, the failure is detected by sensors and the respective data bus B1 or B2, and the respective other brake unit, (for example brake component 20) can then be used by a control device instead of the original brake component 17. Such brake components 17, 18, 20 will then be activated and deactivated by an assigned brake control device.

Finally, control devices are also available for actuating components in the trailer in the form of the components 19, 21 and 22. These components 19, 21, 22 control the brake system or the air suspension system or similar units in the trailer. If one of these transmission units fails, the failure is detected by the sensors and the respective data bus B1 or B2, and another transmission unit performs the function after the assigned control device and its decision means 33 have detected the failure. The decision means can be a component of a control device, or can be provided as a separate circuit or software.

In addition to these components such as sensors, actuators or even relatively simple control devices which are respectively assigned to just one data bus B1 or B2 and do not need to be failsafe, components which are embodied in a duplicate fashion according to the invention or control devices which are embodied in a duplicate fashion are switched in such a way that they each have a transceiver for the data bus B1 and a further transceiver for the data bus B2 so that they can communicate with the two data buses B1 and B2.

The electric motors 23 and 24 are provided with an intelligent control function and embodied in a duplicate fashion. The electric motor 23 is provided, for example, with a manual operator control function, for example a side stick for controlling the vehicle, while the electric motor 24 is connected to the pedal box in order to control, influence or register the activation by the driver's foot. If one of the engine units 23, 24 fails, the failure is detected and the function is performed directly by a second electric motor.

In the example, the side stick 25 is connected to the two electric motors 23 and 24, with the master function being performed by the electric motor 23. That is, the side stick is actuated by the electric motor 23 when there are no faults and on a standard basis. In the event of a fault, when the values which are processed by means of the data buses B1 and B2 in the control units of the electric motors 23 and 24 do not correspond, a decision means 23 will transfer the task of the electric motor 23 to the electric motor 24 so that the latter can interact with the side stick 25. On the basis of this function there is a high degree of failsafety for the side stick 25, the failure of which could, under certain circumstances, cause the vehicle to have an accident. Within milliseconds it is possible to switch over after the detection of a fault so that the master function is performed by the electric motor 24. At the same time, the fault is signaled to the driver so that he can eliminate the fault.

The control devices 26 to 29 are also simultaneously coupled to the two data buses B1 and B2. The control devices 26 to 29 can perform different functions in the vehicle, such as controlling the components in the passenger compartment, actuating engine components, controlling the steering system, or can perform other functions which are critical for safety. Each of these control devices 26 to 29 has two microcomputers. Between the two microcomputers there is an interface at which the messages which are received via the data bus B1 or the data which is calculated therefrom for the first microcomputer μR are compared with that result data which originates from or is calculated on the basis of the messages of the data bus B2 for the second microcomputer μR.

A decision means 33, which is connected to the interface, can be embodied, for example, as a watchdog which checks the satisfactory functioning of the two microcomputers μR and compares their data. The decision means can also be a component of a control device or be provided as a separate circuit or software. In the event of a fault (i.e., when the calculated result data of one microcomputer μR differs from that of the other microcomputer μR), the decision means 33 detects a fault. Depending on the diagnosis the decision means 33 will transfer the functions of the control device (for example, the control device 26) to a standby control device 27 so that the control tasks can then take place in the standby control device 27, while the control device 26 is faulty. The decision means 33 can, however, detect a fault even if a message fails to occur in the time slot or successive messages on the same data bus differ. Depending on the fault routine, a control device then switches itself off or performs the task of another component.

However, it is also possible to provide for only the result data of one of the two microcomputers μR of the control device 26 to be used again after a plausibility check and for the comparison of the result data to be suspended for a predefined time since, after the value range has been checked the system assumes that a microcomputer μR or its sensor system is faulty. In order to actuate the steering system 30, two electric motors 31 and 32 are again provided and can engage electrically, hydraulically or pneumatically in the steering linkage of the vehicle. As a result, the steering behavior of the vehicle can be changed. If one of these steering units fails, the failure is detected by sensors and the control device 31 transfers the control functions to the standby control device 32. However, if appropriate, the control function can also be transferred to one of the other control devices 26 to 29 which have input all the relevant control software from the outset so that the control functions can also be carried out by the control devices 26 to 29 in the event of a fault.

As a result of the connection of the safety-related control devices, actuators and sensors 23 to 32 to the two data buses B1 and B2, the messages on the two data bus systems, and the result data which is calculated therefrom, can be compared with one another in the respective control device 23 to 32. According to the invention, essentially the same hardware and software is provided twice on the microcomputers μR in the control device. In this manner, the result is calculated in duplicate (i.e., redundantly), on the basis of the messages.

In a fault-free situation, identical result data items are thus produced by calculating on the basis of the messages of the respective data bus B1 or B2. If the result data differs, it is easily detected that a fault has occurred in the data bus system. A decision means 33 then distributes the control task to another control device or another microcomputer μR in accordance with a predefined fault handling routine. Two microprocessors μR which each carry out the calculation task are preferably present within the control devices 23 to 32. In this way it is possible to ensure that the calculated data ideally assumes the same value if no fault is present. The microprocessors μR can then still perform other tasks which are not critical for faults. As a result, as well as the failsafe tasks of each control device 23 to 32 it is also possible to carry out other functions, in which case a comparison is not necessary on both microcomputers μR.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-6. (canceled)

7. A redundant data bus system comprising:
two data buses of the same type; and
at least first and second failsafe control devices connected between the data buses; wherein,
safety-related control messages are transmitted and processed in the control devices;
each of the control devices performs a separate control task which, from at least first and second control tasks, which separate control task is processed by means of assigned control software; and
each of the control devices has two microcomputers which operate independently of one another;
the two microcomputers have software for both the first and the second control tasks, whereby when one control device fails, its control task can also be carried out by the other control device; and
each control device includes a data interface between the two microcomputers, by which result data items which are calculated on the basis of the safety-related control messages can be exchanged and compared with one another;
based on the comparison of the result data items, a decision means determines which microcomputer or which control device will carry out a control task; and
the two data buses transmit safety-related control messages in parallel via both data buses.

8. The data bus system as claimed in claim 7, wherein:
a control device, provided as a master control device for a control task, carries out the control task when said control task's sequence runs free of faults; and
in the case of a fault, the decision means transfers the control task to the other control device.

9. The data bus system as claimed in claim 7, wherein connection to one of the data buses occurs for each control task and for each microcomputer.

10. The data bus system as claimed in claim 7, wherein:
each of the two data buses has two bus lines; and
a uniquely defined message receiver is assigned to time slots on the data bus.

11. The data bus system according to claim 7, wherein each microcomputer has the control software for all safety-related control tasks, so that all information for all the safety-related control tasks is provided on each control device.

12. The data bus system as claimed in claim 7, wherein:
the two data buses use the same bus protocol; and
the distribution of time slots is variable, depending on the components connected to the respective data bus.
